(19) United States
(12) Patent Application Publication
(10) Pub. No.: US 2005/0203976 A1
(43) Pub. Date: Sep. 15, 2005

(54) Systems, tools and methods for transferring files and metadata to and from a storage means

(75) Inventors: William Hyun, Tiburon, CA (US); Martin Bigos, San Francisco, CA (US); Antony Chiang, San Francisco, CA (US); Lawrence Roberts, San Francisco, CA (US)

Correspondence Address: LAW OFFICE OF ALAN W. CANNON, 834 SOUTH WOLFE ROAD, SUNNYVALE, CA, 94086, US

(73) Assignees: University of California; Biotrue, InC.

(21) Appl. No.: 11/055,424

(22) Filed: Feb. 9, 2005

Related U.S. Application Data
(60) Provisional application No. 60/544,122, filed on Feb. 11, 2004.

(51) Int. Cl. G06F 17/30

(52) U.S. Cl. 707/204

(57) ABSTRACT

Methods, tools and systems for efficiently and intuitively transferring files from client computers, via a network, to a centralized location for storage of the files as well as storage of metadata associated with the files in a manner such that the metadata as well as the files may be searched in the database by users to identify files of interest.

### CROSS-REFERENCE

This application claims the benefit of U.S. Provisional Application No. 60/544,122, filed Feb. 11, 2004 which application is incorporated herein, in its entirety, by reference thereto.

### GOVERNMENT RIGHTS

This invention was made with government support under federal grant no. 2R44 RRO18043-02 awarded by the Department of Health and Human Services (National Institutes of Health). The United States Government may have certain rights in this invention.

### FIELD OF THE INVENTION

The present invention relates to a method of transferring information or files in the field of computer software. More particularly the invention relates to a method of transferring files efficiently and intuitively from a user computer to a storage means.

### BACKGROUND OF THE INVENTION

For many organizations, staff and users are dispersed throughout one building or many geographic locations, each user with his or her own computer and each user generating computer data and files. Data and computer files that reside on one person's computer are often needed by many others in the organization. For example, a biomedical research laboratory may have five instruments IA,IB,IC,ID,IE, each directly linked with a computer CA,CB,CC,CD, and CE, respectively. Further, ten researchers, R1-R10, each of which use one or more of the instruments IA-IE, also each have their own workstation computer, such as a desktop computer or laptop, C1-C10. On a typical day, researcher R1 may create one hundred new research data files with Instrument IA, which are saved to the attached or directly connected computer CA. When researchers R2 and R3 are also involved in the research conducted by researcher R1, they will generally need to have access to the one hundred new data files created by R1 for this project. Computer CA may not be set up with the appropriate analysis software to conduct the research analysis, and even if it does, it is highly inefficient to expect each of researchers R1, R2 and R3 to wait their turns to access the data files, each from the same computer CA.

Typically, the researchers R1, R2 and R3 will each need access to the data files from their workstations C1, C2 and C3.

The most efficient way of providing each researcher the needed access to the data files, is to store the data files on a centralized storage device. Many times, computers (such as CA-CE) are “stand-alone” computers that do not even have the capability of transferring the data files through an interconnection with a central storage device, such as a server or centralized database. In this case, researcher A is forced to copy the files to physically transportable media, such as floppy disks, cd-rom or the like, transport the files, via the physically transportable media to a computer (e.g., C1) which is interconnected via a network to the central storage facility, loading the files onto the connected computer, and then transfer the files to the centralized storage location.

Current computer file systems provide several methods for dispersed users to collect their files into a central location. For example, the research lab may have set up a central file server to provide access to all of the lab's shared files. The most common method is to set up a shared hard disk on the central file server and for users to connect to that hard drive using their operating system's built in peer-to-peer networking functionality. Then the user can copy the files from his or her computer to an appropriate folder on the central file server hard drive. So for example, once Researcher A has copied the new 100 research data files to the central file server, Researchers B and C can open up the shared file server folder and retrieve the files using their operating system's networking tools.

Even when the instrument computers are directly connected into the centralized storage facility via a network, the method of setting up a shared hard drive is inadequate when critical metadata about the files is necessary to catalog, organize, and manage the files. A particular data file may have numerous file attributes (i.e., metadata) attached to it such as the file name, date of creation, type of instrument creating the file, file type, date of modification, patient identity, tumor type, project, researcher, etc. A biomedical researcher may generate hundreds or thousands of such files weekly and need to easily organize and retrieve files based upon a variety of metadata. As a result, the laboratory must set up a database system that will catalog the metadata of the files being stored on the central file server.

Current cataloging database systems provide for several methods of transferring the files to a central location and storing related metadata. However, existing methods do not allow for the user to intuitively and frequently transfer the data files into the database and central location. Existing methods either require multiple, time consuming steps to complete the process, or cumbersome, non-intuitive methods to reduce the number of steps required to complete the process, relative to methods requiring multiple, time consuming steps.

For example, one existing method provides that the user complete the following steps: logging into the database software using client software or a web browser; choosing an “import transfer” feature; selecting files to be transferred on the user's local drive; selecting the placement within the database file structure where the files are to be stored upon transfer; inputting critical metadata about the files, and then transferring the files with inputted metadata. This ‘master software’-centric method and user interface, where everything must be done from within the primary cataloging software, is easiest for the programmer to implement, but requires the greatest amount of time and steps on the part of the user. This method is especially common in web-based and client/server based database applications with central file storage features.

Another example is provided in U.S. Pat. No. 6,260,044, which describes a method in which the user 1) starts from the third party software that generates the files such as a spreadsheet, instrumentation or analysis software, 2) selects the print function and “prints” to the cataloging database rather than a physical printer, 3) logs into the cataloging database, 4) selects the placement within the database file structure for ‘pending’ files imported through the ‘print’ function and 5) inputs critical metadata about the files. This method provides for format conversion advantages, but does not save any labor steps for the end user, nor does it work intuitively or seamlessly with the user's workflow. This is especially true, in typical cases, such as the example described in paragraphs [0004] and [0005] above, when a user needs to transfer many files on a regular basis. Continuing the example described in paragraphs [0004] and [0005] above, where researcher R1 has generated one hundred new data files, this technique would require researcher R1 to ‘print’ each file to the database.

A third existing method has its origins from administrative ‘archiving’ procedures. Using this method, users may, in advance, administratively set up a regularly scheduled sweep of each client computer hard drive, specifying certain folders to evaluate. If new files have been identified since the last scheduled archive, those files are automatically transferred to the central storage location. If the automatic archiving has no intelligence built in, then when the user logs into the cataloging database, he or she must then complete the steps of 1) identifying where the automatically uploaded files should go in the database, and 2) input critical metadata about the files. This method has disadvantages such as 1) requiring the user to wait until the scheduled sweep occurs, which may be problematic when the user wants to move files to the cataloguing system immediately, perhaps to allow access by another user who needs them; 2) forcing rigid hierarchy or organization of folders on the client desktop; requiring the user to manually input metadata if multiple users utilize the same computer to generate data files, such as is generally the case with computers attached or directly connected to a laboratory instrument and which are networked with the cataloguing system; and 3) causing a time gap between the time of generation of a data file, and the time of creation of the metadata characterizing that data file, unless, by pure chance, the data file creation is completed just as the sweep of the computer having generated the data file is initiated on that computer, and which has a low probability of occurrence.

Thus, there is a need for more direct and intuitive methods for transferring files and associated metadata to a central location. These needs are even more pronounced in environments where users/organizations share such files, and which files are created by multiple users and accessed on multiple computers. Even for purposes of storage to a computer user's own local storage devices, there is a need for more efficient, intuitive mechanisms for repeated transfers of files without the need to repeatedly input a great deal of the same information each time a file is to be transferred.

### SUMMARY OF THE INVENTION

The present invention provides methods for facilitating an efficient and intuitive transfer of files from a computer to a storage device. Although particular examples are given with respect to sending files to and from a client computer to and from a centralized data storage system via a network, the present application is also applicable to local storage methods, such as the transference of files from a user's computer to a local storage device. Methods disclosed may include the steps of: setting up a template for storing files to a particular location on the storage device, wherein upon set up, the template stores metadata information regarding the particular location where the files are to be stored; creating a drop box to be regulated according to metadata information stored in the template; transferring the set up template to the computer for use thereof; and adding the drop box to a user interface of the computer, wherein the drop box automatically transfers the files from the computer to the particular location of the storage device when the files are dragged and dropped onto the drop box.

The metadata information stored by the template may further include metadata characterizing the files to be stored.

The metadata information stored by the template may further include user identification data.

The metadata regarding the particular location where the files are to be stored in the storage device may be set up in the template by a user's act of accessing the storage device and navigating to the particular location.

A method of efficiently and intuitively transferring files between a computer and a storage device is provided, including the steps of: dragging and dropping a file to be transferred onto a drop box provided on a user interface of the computer; checking metadata associated with the file to determine whether the file is valid to be transferred via said drop box; and if the file is determined to be valid, automatically sending the file to a predefined location in the storage device.

The above method may be practiced between a client computer and a centralized storage means, via a network.

The above method may be practiced locally between a user's computer and a local storage device either contained in, or external to the user's computer.

The predefined location to which the file is automatically sent may be identified by metadata stored in a template associated with the drop box.

Metadata associated with the file may be extracted and sent with the data of the file to the predefined location in the storage device. Thus, both the data and metadata may be stored in the predefined location.

The method provides for repeated automatic file sending of different files according to the steps of: dragging and dropping a file to be transferred onto a drop box provided on a user interface of the computer; checking metadata associated with the file to determine whether the file is valid to be transferred via said drop box; and if the file is determined to be valid, automatically sending the file to a predefined location in the storage device.

Files may be encrypted during transfer between the computer and storage device, and the system provides for decrypting both files and metadata at both the location of the computer as well as the location of the storage device.

If access to the storage device cannot be established when the file is determined to be valid, the drop box stores the file to be transferred and automatically transfers the file when access to the storage device can again be established.

A method of efficiently and intuitively transferring files between a computer and a storage device is provided to include setting up a drop box application within the storage device for storing files to a particular location in the storage device; initializing the drop box application on the computer; and automatically sending a file and associated metadata by the drop box application to the particular location in the storage device. The computer may be a client computer and the storage device may be located in a centralized data storage system, or the computer may be a computer storing to a local storage device and the storage device may be any form of local storage media and associated database management software, for example.

Additional files may be subsequently sent automatically, when the files share common metadata characteristics with the file described as being automatically sent above, without the need to carry out setting up and initializing steps.

Set up of the drop box application within the storage device may include setting up a template for storing files to a particular location in the storage device, wherein upon being set up, the template stores metadata information regarding the particular location where the files are to be stored in the storage device. The metadata information may include further metadata, such as metadata characterizing the files to be stored and/or user identification data, for example.

The step of initializing the drop box application on the computer may include transferring the set up template to the computer for use thereof; and adding the drop box to a user interface of the computer.

The step of automatically sending a file and associated metadata by the drop box application to the particular location in the storage device may include dragging and dropping the file onto a drop box icon visualized on a user interface of the computer, which activates the automatic sending by the drop box application.

The template is stored on the computer.

The metadata information regarding the particular location where the files are to be stored in the storage device may be set up in the template by a user's act of accessing the storage device and navigating to the particular location.

A system for efficiently and intuitively transferring files between a computer and a storage device is provided to include means for setting up a drop box application within the storage device for storing files to a particular location in the storage device; means for initializing the drop box application on the computer; and means for automatically sending a file and associated metadata by said drop box application to the particular location in the storage device. The system may be applied to client computer for communication with a centralized storage means, via a network, or locally, between a user's computer and a local storage device either contained in, or external to the user's computer, for example.

Means for setting up a drop box application within the storage device may include means for setting up a template for storing files to a particular location in the storage device, wherein the template stores metadata information regarding the particular location and characterizing the files to be stored in the particular location.

Means for initializing the drop box application on the computer may include means for transferring the set up template to the computer; and means for establishing the drop box application on a user interface of the computer.

Means for automatically sending a file and associated metadata may include a drop box icon on the user interface, wherein the drop box icon is automatically actuatable when a valid file is dropped thereon, to automatically send the valid file and metadata associated therewith.

Metadata information regarding the particular location where the files are to be stored in the storage device may be set up in the template by a user's act of accessing the storage device and navigating to the particular location.

Means for automatically sending may further include means for storing the file in the drop box application when the storage device is not currently accessible by the computer, wherein the means for automatically sending automatically sends the stored file when access to the storage device is re-established.

A tool for facilitating an efficient and intuitive transfer of files between a computer and a storage device is provided to include means for setting up a template for storing files to a particular location in the storage device, wherein upon set up, the template stores metadata information regarding the particular location and characterizing the files to be stored in the particular location; means for creating a drop box to be regulated according to metadata information stored in the template; means for transferring the set up template to the computer for use thereof; and means for adding the drop box to a user interface of the computer, wherein the drop box automatically transfers the files from the computer to the particular location of the storage device when the files are dragged and dropped onto the drop box.

The tool may be applied to client computer for communication with a centralized storage means, via a network, or locally, between a user's computer and a local storage device either contained in, or external to the user's computer, for example.

In a specific example of preparation of the template, the template is a ticket.

Means for setting up a template may include means for automatically setting-up the metadata regarding the particular location where the files are to be stored in the storage device, by a user's act of accessing the storage device and navigating to the particular location.

A tool for efficiently and intuitively transferring files between a computer and a storage device is provided to include a drop box automatically actuatable by dragging and dropping a file to be transferred thereon; means for checking metadata associated with the file to determine whether the file is valid to be transferred via the drop box; and means for automatically sending the file, when determined to be valid, to a predefined location in the storage device.

The tool may be applied to client computer for communication with a centralized storage means, via a network, or locally, between a user's computer and a local storage device either contained in, or external to the user's computer, for example.

The tool may further be provided with means for storing metadata identifying the predefined location, wherein the drop box accesses the metadata to determine where to send the file.

Further, the tool may include means for extracting and sending metadata associated with the file to the predefined location in the storage device.

Still further, the tool may include means for storing the file prior to automatic sending, wherein, if access to the storage device cannot be established when the file is determined to be valid, the drop box stores the file to be sent and automatically sends the file when access to the storage device is re-established.

A computer readable medium is provided, carrying one or more sequences of instructions for facilitating an efficient and intuitive transfer of files between a computer and a storage device, wherein execution of one or more sequences of instructions by one or more processors causes the one or more processors to perform the steps of: setting up a template for storing files to a particular location in the storage device, wherein upon set up, the template stores metadata information regarding the particular location and characterizing the files to be stored in said particular location; creating a drop box to be regulated according to metadata information stored in the template; transferring the set up template to the computer for use thereof; and adding the drop box to a user interface of the computer, wherein the drop box automatically transfers the files from the computer to the particular location of the storage device when the files are dragged and dropped on the drop box.

The executable sequences of instructions may be set up for application to a client computer for communication with a centralized storage means, via a network, or locally, between a user's computer and a local storage device either contained in, or external to the user's computer, for example.

A computer readable medium is provided, carrying one or more sequences of instructions for efficiently and intuitively transferring files between a computer and a storage device, wherein execution of one or more sequences of instructions by one or more processors causes the one or more processors to perform the steps of: automatically activating a transfer process when a file to be transferred is dropped onto a drop box provided on a user interface of the computer; checking metadata associated with the file to determine whether the file is valid to be transferred via the drop box; and if the file determined to be valid, automatically sending the file to a predefined location in the storage device.

The executable sequences of instructions may be set up for application to a client computer for communication with a centralized storage means, via a network, or locally, between a user's computer and a local storage device either contained in, or external to the user's computer, for example.

A computer readable medium is provided, carrying one or more sequences of instructions for efficiently and intuitively transferring files between a computer and a storage device, wherein execution of one or more sequences of instructions by one or more processors causes the one or more processors to perform the steps of: setting up a drop box application within the storage device for storing files to a particular location in the storage device; initializing the drop box application on the computer; and automatically sending a file and associated metadata by said drop box application, to the particular location in the storage device.

The executable sequences of instructions may be set up for application to a client computer for communication with a centralized storage means, via a network, or locally, between a user's computer and a local storage device either contained in, or external to the user's computer, for example.

Thus, the present invention provides systems, tools and methods and computer readable media for efficiently and intuitively transferring files from computers, such as client computers via a network, to a centralized location, or a computer to a local storage device, for storage of the files as well as storage of metadata associated with the files.

A template may be predefined to store information regarding transference of files to a designated location in a central cataloguing database or local storage device. Such a template may store metadata characterizing files that will be sent according to such template, thereby relieving a user from having to manually input such data each time a file is sent and stored to the same location.

Security checks may be performed to ensure that a user attempting to upload a file or files is authorized to access the central database and is authorized to access the particular location of the database that the user is attempting to upload to. Additionally, security checks may be performed to ensure that the file or files being uploaded are authorized to be deposited in the requested location. Similar security checks may be put in place for local storage applications.

Files, as well as metadata, may be encrypted during transfer, whether during uploading to the central database, or downloading from the central database to one or more client computers.

The present systems, tools, methods and computer readable media facilitate users of a shared cataloging file database system, or other similar software system, to transfer files from dispersed computers into a centralized cataloging system in an intuitive manner, requiring a minimum of steps to complete the action and minimum input from the end user, while still capturing key metadata about the files.

The present invention allows users to set up multiple simple iconic ‘drop boxes’ on their computer desktops; generate files in a way consistent with their current work flow and save those files in any manner they currently find efficient and comfortable; ‘drag and drop’ files or folders onto a particular drop box icon; provide for the automatic transfer and cataloging of the files in a centralized database, without further action required by the users; and automatically save metadata about the files already associated with a particular drop box in the centralized database with the files.

These and other advantages and features of the invention will become apparent to those persons skilled in the art upon reading the details of the invention as more fully described below.

### BRIEF DESCRIPTION OF THE DRAWINGS

FIG. 1 is a schematic representation of an exemplary network, such as a laboratory network, to show a typical network that the present invention may be employed in.

FIG. 2 is a flowchart describing an administrative setup of a drop box, according to the present invention, within a master cataloging database software that runs a cataloging function of a cataloging database system.

FIG. 3A is an illustration of a tool for facilitating the creation/setup of tickets according to the present invention.

FIG. 3B is an illustration of use of the tool shown in FIG. 3A for creating a drop box according the present invention.

FIG. 3C is a schematic representation of a user interface, simulating the dragging and dropping of a file onto a drop box according to the present invention.

FIG. 4 is a flow chart illustrating three sub-processes that may be implemented according to the present invention.

### DETAILED DESCRIPTION OF THE INVENTION

Before the present system, tools and methods are described, it is to be understood that this invention is not limited to particular datasets, data sources, networks, method steps, tools or applications described, as such may, of course, vary. It is also to be understood that the terminology used herein is for the purpose of describing particular embodiments only, and is not intended to be limiting, since the scope of the present invention will be limited only by the claims.

Unless defined otherwise, all technical and scientific terms used herein have the same meaning as commonly understood by one of ordinary skill in the art to which this invention belongs. Although any methods, software and/or hardware similar or equivalent to those described herein can be used in the practice or testing of the present invention, the preferred methods, tools and hardware are now described. All publications mentioned herein are incorporated herein by reference to disclose and describe the methods and/or materials in connection with which the publications are cited.

It must be noted that as used herein, the singular forms “a”, “and”, and “the” include plural referents unless the context clearly dictates otherwise. Thus, for example, reference to “a file” includes a plurality of such files and reference to “the client computer” includes reference to one or more client computers and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates that may need to be independently confirmed.

### DEFINITIONS

The term “file” as used herein, refers to any data structure that can be stored in a hard-drive or other storage device. As used, the term “file” refers not only to a single data file, in accordance with its general use, but also includes groups of files, such as folders, directories, etc.

“Cataloging database system” refers to cataloging database management software for centrally organizing a database of files, and hardware to support the same. Files may be organized and stored directly on a central server or stored in a database memory that is connected to a central server, for example. Examples of cataloging database management software include, but are not limited to Biotrue Research Data Management System http://www.biotrue.net/site/main/section/36, and Interwoven DeskSite http://www.imanage.com/products/worksite/deskmail_site.html.

A “storage device” refers to any form of storage media that may be used to store files and having associated database management software. For example, a storage device may refer to a computer's internal hard drive and software associated with managing the hierarchy of such storage, or an external storage device and associated software for managing the hierarchy of where the files are stored on the storage device. A storage device may also refer to centralized storage means.

The term “centralized storage means” refers to a storage device and associated database management software that is networked with more than one client computer and thus capable of storing files from more than one computer. Centralized storage means may include a cataloging database system or other networked storage device, which may be distributed among more than one location, for example.

A “drop box” as used herein, refers to a software tool that enables intuitive transfer of one or more files from a client computer to a centralized cataloging database.

A “client computer” refers to a computer that is remotely located from the cataloging database system, but that can communicate with a centralized computer associated with the cataloging database system, to upload and/or download files from the cataloguing database system.

A “ticket” as used herein, refers to a template that stores metadata information about files to be uploaded from a client computer to a cataloguing database system.

A “processor” references any hardware and/or software combination which will perform the functions required of it. For example, any processor herein may be a programmable digital microprocessor such as available in the form of a mainframe, server, or personal computer (desktop or portable). Where the processor is programmable, suitable programming can be communicated from a remote location to the processor, or previously saved in a computer program product (such as a portable or fixed computer readable storage medium, whether magnetic, optical or solid state device based). For example, a magnetic or optical disk may carry the programming, and can be read by a suitable disk reader communicating with each processor at its corresponding station.

### DETAILED DESCRIPTION OF SPECIFIC EMBODIMENTS

The present invention provides systems, tools, methods and computer readable media that enable users of a shared cataloging database system, or other centralized storage means, to transfer files from client computers into the centralized cataloging system/storage means in an efficient, intuitive manner that requires much fewer interactive steps by the user to complete the transfer and cataloging actions while still capturing key metadata about the files. The present systems, tools, methods and computer readable media may also, or alternatively be used with a computer for local storage of files.

The present invention facilitates the setup up of a drop box on a computer or client computer that is configured to transfer a file from the computer or client computer by simply dragging and dropping the file on the drop box. This greatly simplifies the process of transferring data files to a storage device/centralized location for storage of the files as well as storage of metadata associated with the files in a manner such that the metadata as well as the files may be searched in the database by users to identify files of interest.

Further, the implementation of the present invention permits users to generate files in a way consistent with their current work flow and to save those files in any manner they currently find efficient and comfortable, as the system, including a drop box pertaining to specific files does the work required for properly cataloging the files as they are transferred, as well as extracting and cataloging associated metadata. Thus, a user need merely drag and drop a file or files from a computer/client computer onto an appropriate drop box on the same computer/client computer, which initiates a file transfer, wherein the system provides for automatic transfer and cataloging of the file or files without further action required by the user. Useful metadata associated with the file or files is already associated with the particular drop box used to transfer the files and identifies the categories of metadata to be extracted and automatically saved in the database with the files.

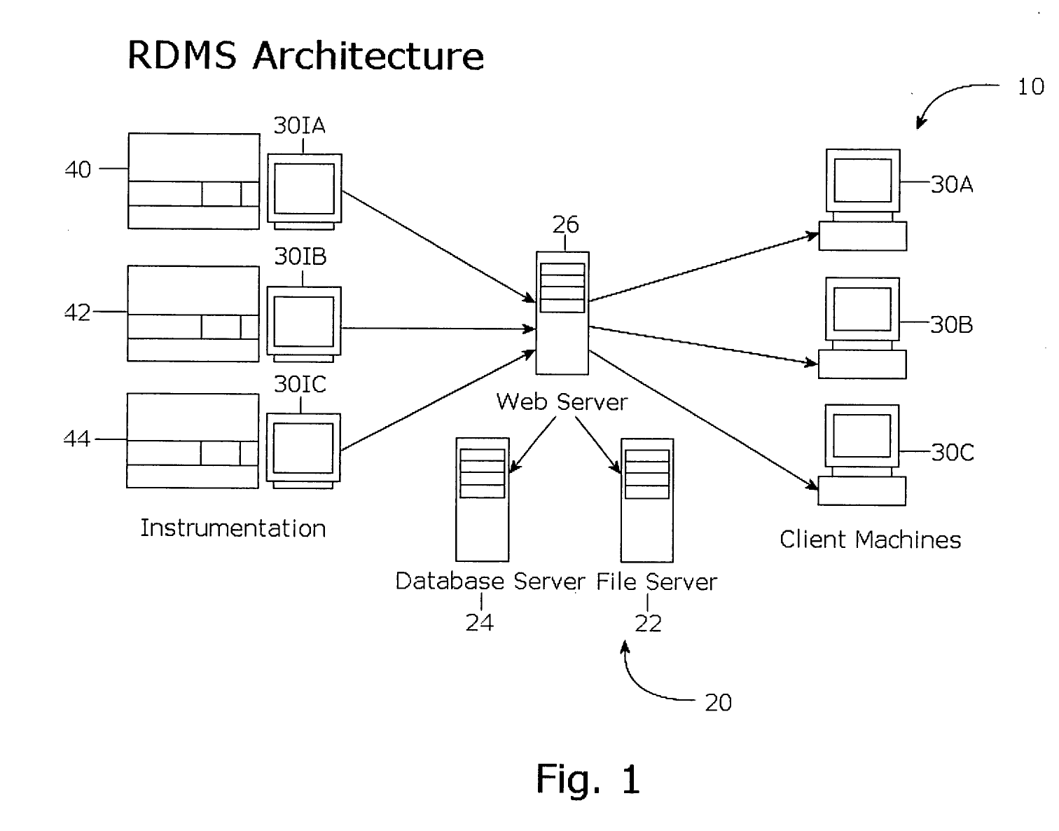

Referring now to FIG. 1, a schematic of an exemplary network, such as a laboratory network, is illustrated to show a typical network that the present invention may be employed in. It is noted here that the present invention is not limited to use with laboratory networks, but is useful for any network where the users of the network desire to save files to a central storage location, in a manner where they are catalogued not only as to a file cataloguing structure, but also as to associated metadata, such that the central storage location provides a searchable database of the files by searching the files directly and/or searching metadata associated with the files. Further, as noted above, present invention is not limited to use with networked computers using centralized storage means, but is also useful for any computer to save files to a local storage device, in a manner where they are catalogued not only as to a file cataloguing structure, but also as to associated metadata, such that the storage device provides a searchable database of the files by searching the files directly and/or searching metadata associated with the files.

Network 10 includes a centralized cataloging database system 20 that is used to centrally store, in an organized and searchable database, files and metadata associated with the files, that may be created and uploaded from any of client computers 30A, 30B, 30C, 30IA, 30IB and 30IC. In this example, cataloguing database system 20 includes files server 22 for central storage of files, database server 24 for managing and cataloging the files on file server 22 and web server 26 which interfaces between the client computers and the file and database servers. It is noted however, that different configurations may be provided for cataloging database system, depending upon the need of the particular network. For example, file storage and database management software may be stored on a single server, which may be a web server or not, if the network is established as an intranet, for example.

In this example, laboratory instruments 40, 42 and 44 are directly connected to client computers 30IA, 30IB and 30IC, respectively, such that data created, measured or otherwise obtained by instruments 40, 42 and 44 may be directly stored as files in client computers 30IA, 30IB and 30IC, respectively. Client computers 30IA, 30IB and 30IC, in turn, are configured to upload the data files to cataloging database system 20, and may be further configured to access and download files from cataloging database system 20. Similarly, client computers 30A, 30B and 30C are computers from which a user may upload and download files to and from cataloging database system 20.

In order to provide a user with an efficient and intuitive system for managing files, the system permits the user to set up a drop box which may be visually displayed on the user interface of (e.g., the desktop of) the user's client computer 30A,30B,30C,30IA,30IB,30IC that may be used to drag and drop files thereon for automatic uploading of the files to the cataloging database system 20. The present invention optimizes the efficient transfer of files and associated metadata to cataloging database system 20.

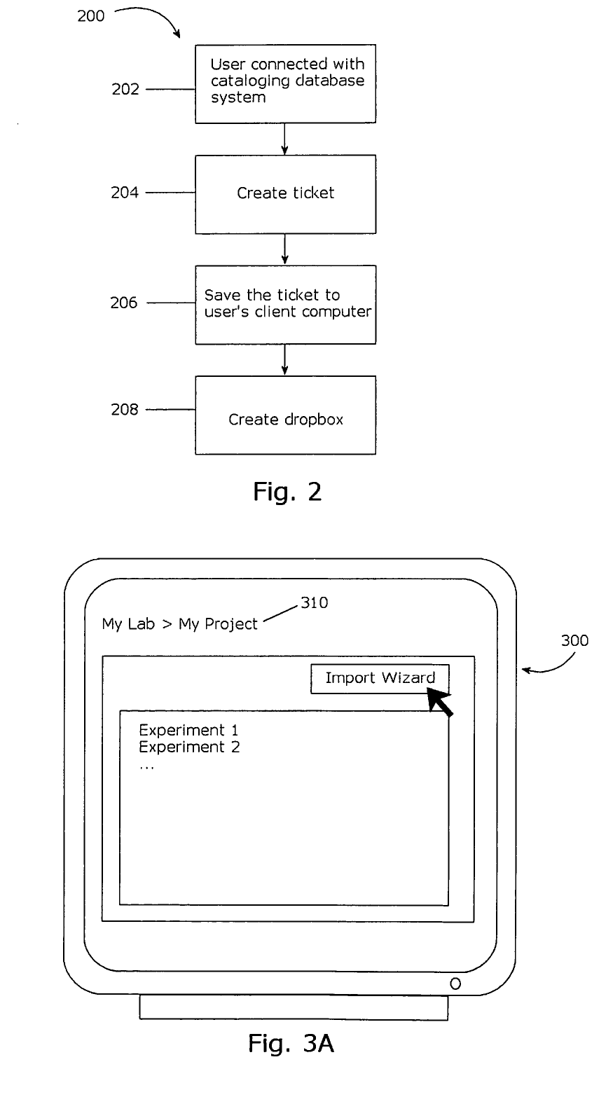

FIG. 2 is a flowchart 200 describing the administrative setup of a drop box within the master cataloging database software that runs the cataloging function of cataloging database system 20. Initially, a user must be connected with cataloging database system 20 and capable of accessing cataloging database system 20. For security purposes, cataloging database system 20 may be provided with permissions requirements as to whether a user can access cataloging database system 20 at all, and further, optionally, permissions levels which provide only limited access to particular locations in the database, all the way up to full access. Thus, a user may need to successfully enter a login name and password to gain initial access to cataloging database system 20, and once admitted, cataloging database system 20 may perform a further security check to determine what permissions level the particular user is assigned to determine which files the user may access.

At step 204, assuming that the user has access to the particular location that the user is interested in storing/accessing files, the system facilitates the user in setting up a ticket. Once created, the ticket provides a template of the steps that would otherwise need to be taken by the user to store a file in the specified particular location on cataloging database system 20, each time a file is uploaded. Since the ticket effectively stores this information, the user only has to input these details once for each ticket created, and the details are applied each time the user uploads a file to the same location in cataloging database system 20. The ticket may also store metadata information such as laboratory identifier, identification of user and identification of project, for example. However, merely by storing the location details of where the files are to be stored in the storage device (e.g., cataloging database system 20, in this example), metadata information regarding laboratory identifier, project identification, etc. may already be known/stored by the storage device, since these are parameters that may have been used to set up that storage location. In this case, the ticket need not store this information, since it can be automatically obtained at the storage device. Therefore, only location metadata, and optionally, user identification metadata may need to be stored in the ticket. Optionally, the ticket may contain information that tells the system which categories of metadata to extract, such as size, resolution, pixel density, etc. However, the system is currently set up to detect the type of file (e.g., jpg, gif, doc, etc.) that is attempted to be uploaded, and automatically extract the metadata within the file. In either case, metadata about files, as well as the files that the metadata are associated with are uploaded to the specified location in cataloging database system 20. This information may include, but is not limited to: destination in the hierarchy of cataloging database system 20, data type, identifier as to what person performed the data gathering and/or generated the file, etc.

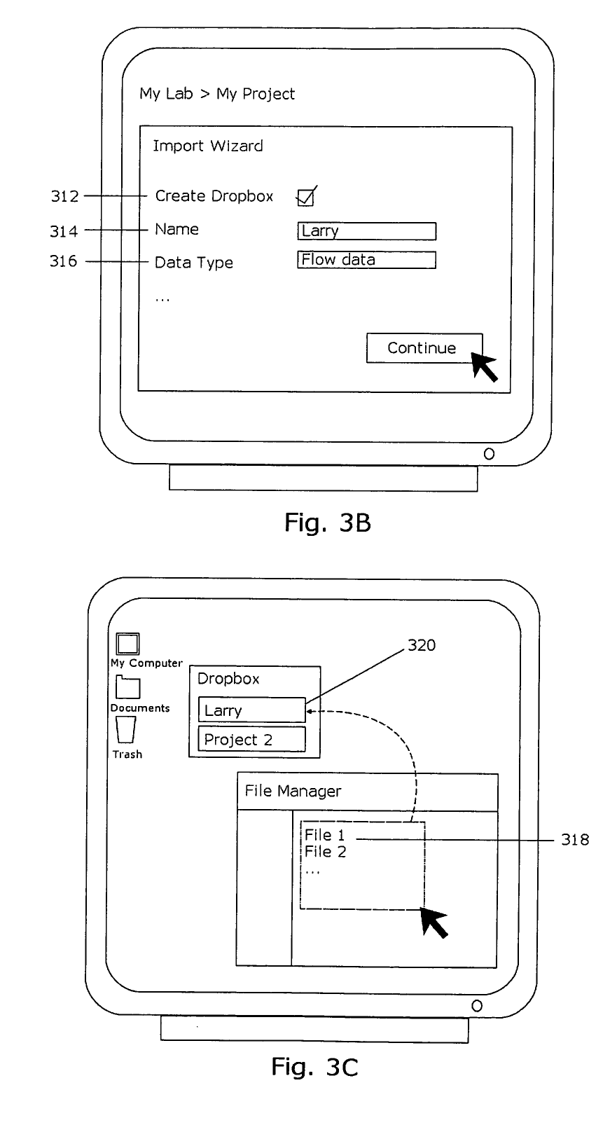

One example of a tool for facilitating the creation/setup of tickets is import wizard 300, a screen shot of which is shown schematically in FIG. 3A. In this implementation, the user has logged in and gained access to cataloging database system 20, within which the user navigates to the location within the cataloging database where the user wishes to import (upload) additional files (in this example, Experiment 1 and Experiment 2), which, in this example is the location in the cataloging database identified as “My Lab>My Project” 310. The act of navigating to the desired location in cataloging database system 20 at the same time sets up the ticket with the address of the desired location, thereby providing an intuitive and relatively effortless procedure for the user to set the ticket up with the address details, without requiring manual data entry. However, it is noted that ticket setup may be implemented with alternative tools, such as providing the user with a data entry form on which the user may fill in address details and/or any number of other metadata fields.

Import wizard 300 further prompts the user (see FIG. 3B) to create a drop box which will be regulated according to the information set up in the ticket created, which, in this case, includes the user's name 314 and data type 316, in addition to the address of the desired location in cataloging database system 20 and any other metadata categories that may be considered important for extraction from the imported/uploaded files so as to be searchable within cataloging database system 20.

Upon completion of the creation/setup of a ticket, the system saves the ticket to the user's client computer in a designated ticket directory. Optionally, the ticket may be encrypted for sending to the user's client computer, where, upon receipt there, it is decrypted and stored in the designated ticket directory. Tickets may be saved to the designated ticket directory as text files or configuration files with custom format and syntax, or alternatively may be saved and accessed as records in cataloging database system 20. Once the ticket has been saved, the system's application software updates to add a new drop box to the user's interface at step 208. Note that each ticket created corresponds to a separate drop box, and thus there are multiple drop boxes created when multiple tickets are created. Once a ticket is created for a particular project, for example, the user may easily and automatically import files into the location on cataloging database system 20 created for that project, without having to enter any details to direct the imports.

Further, when tickets are stored on the client computer, the stored information in a ticket allows a user to drag and drop a file to each ticket's associated drop box even when the client computer is not capable of importing/uploading the file to cataloging database system 20. In this situation, once the client computer regains the ability to import the file to cataloging database system 20, the file is automatically uploaded without the requirement of any further intervention by the user. Situations where this feature is useful include instances when cataloging database system 20 is “down” or offline, instances when the client computer is incapable of connecting with the network (e.g., such as when the client computer is a portable computer, such as a laptop, palmtop or other portable computing device which is out of range, or otherwise temporarily disconnected with the network) and the like.

Drop boxes may be created for example, using a drag and drop item from JAVA API (application programmer's interface). A “notify” object is included so that the drop box is notified when an object is dragged over it. The ticket associated with the drop box identifies a flavor (e.g., string, file, etc.) that must be matched by the flavor of the object dragged onto the drop box, in order for the drop box to continue processing the operation. If the flavor of the object is acceptable, then the file is automatically uploaded to cataloging database system 20, to the location identified by the associated ticket, and the system extracts metadata as identified by the associated ticket and stores the extracted metadata in the location(s) in cataloging database system 20 identified by the associated ticket.

FIG. 3C is a schematic representation of a user interface, simulating the dragging and dropping of a file 318 (i.e., “File 1”) onto drop box 320 (i.e., Larry) to be automatically uploaded to cataloging database system 20.

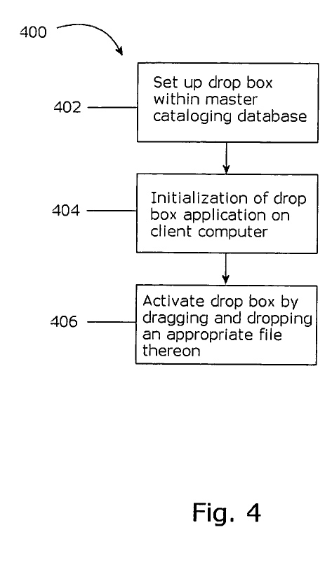

In implementing the present system on a particular user's client computer, the implementation can generally be identified by three sub-processes as shown in the flowchart 400 of FIG. 4. Initially, a drop box is set up within the master cataloging database of cataloging database system 20 at step 402, such as by the ticket generation process described above with regard to FIG. 2. Next, the initialization of the drop box application is performed on the user's client computer at step 404, which may include storing a ticket on the user's client computer, and the associated establishment of the drop box on the user interface, as described above. Once the set up procedures of steps 402 and 404 have been completed, a file may be automatically uploaded from the user's client computer to cataloging database system 20 when the user activates the drop box at step 406 by dragging and dropping a file that meets the requirements set by the ticket onto the drop box.

Table 1 provides a pseudocode as an example of a method that has been implemented in particular to transfer files. As indicated files may be transferred to a central storage location along with the ticket information utilizing operating system tools, local client applications and transfer protocols.

TABLE 1
Pseudocode example:

001 server receive http request for ticket
002 process post info
003 check current user permissions
004 check current target state (check out etc.)
005 create ticket
006 encrypt ticket
007 save ticket to client machine
008 notify client
009 end request
010 client ticket watch thread
011 ticket thread
012 scan dir contents
013 if new file found
014 decrypt ticket
015 check is valid ticket
016 check not in ticket array
017 parse ticket info
018 create ticket object
019 create ticket ui
020 add ticket ui to ui list
021 add ticket obj to set
022 end if
023 if not all set elements in ticket dir
024 remove missing elements from set
025 end if
026 end ticket thread
027 client ticket ui object thread
028 event loop listener
029 if gui drag over
030 display drag ready
032 end if
033 if gui drop
034 get drop event object
035 get data flavor from obj
036 if flavor acceptable
037 block further drops for this box, ui reflect
038 extract transferable
039 create import manager
040 pass transferable to import manager
041 call import manager import method
042 manager uploads according to transferable flavor
043 manager calls server with import details
044 server imports according to data flavor
045 server returns status to manager, ui reflect
046 manager expires
047 box re-opened, ui reflect
048 else
049 reject drop, ui reflect
050 end if
051 end if
052 end event loop

Lines 001-009 describe a process of creating a ticket, sending it to the user's client computer and storing it there, as has been described above. At line 001, cataloging database system 20 receives a request for a ticket when a user logs in, for example through web server 26 via an http request. Post information, such as data type id, user id, target run id (identifying location in cataloging database system 20) and the like are processed at line 002. Current user permissions are checked at line 003 to ensure that the user is authorized to generate the ticket that is being requested. The ticket is then created and encrypted at lines 005-006 and then sent and saved to the client computer at line 007, at which time a notification is sent to the application at the client computer to update the user interface with a new drop box (line 008).

Lines 010-026 describe an example of ticket thread processing by the system. The user is provided with an executable application on a client computer that initiates the drop box interface. When the drop box application is first launched, the user's ticket directory is scanned (line 012) to determine whether any new ticket files have been sent to the client computer and stored in the ticket directory. If a new file is found (013) the file is decrypted (if it is an encrypted file, line 014) and then checked (line 015) to determine whether it is a valid ticket. Valid tickets include metadata information of the type that is automatically extracted, in a predefined format. If a file is accidentally or otherwise mistakenly placed in the directory, it will be ignored as not containing metadata of the predefined format. If, on the other hand the file is determined to be a valid ticket, the information contained in the ticket is parsed (line 017), from which a ticket object is created (line 018) and a ticket user interface (e.g., drop box is created and added to a ticket user interface list (line 020). A ticket object is added to a set of ticket objects at line 021. At lines 023-024, the system checks to see whether the user has altered the ticket directory, by removing one or more tickets from the ticket directory. For example, if there are three drop boxes in the drop area of the drop box application, corresponding to three tickets in the ticket directory, but prior to processing by the drop box, the user decides to delete one of the tickets in the ticket directory, then line 024 instructs the drop area/drop box application to remove the drop box corresponding to the deleted ticket so that only two drop boxes remain.

Lines 027-049 describe an event loop listening process, which facilitates the initiation and processing by a drop box. At line 029, if a user attempts to drag an object, the display of the object is changed on the user interface to indicate a drag-ready status at line 030. When the object is dragged and dropped onto the drop box, the event loop listener identifies the drop and gets the drop event object at line 034. The flavor of the dropped object is then checked at line 035 to determine whether it is an acceptable flavor as identified by the ticket associated with the drop box. If the flavor is acceptable at line 036, then the transferable information (e.g., file and specified metadata) are extracted from the object at line 038. An import manager is created at line 039 and the extracted transferable information is passed to the import manager at line 040. The import manager import method is next invoked at line 041, at which time the import manager uploads the transferable information according to the transferable flavor as approved by the ticket settings (line 042). The import manager calls the server (e.g., cataloging database system 20) (line 043), which then imports the transferable information according to the identified data flavor. Upon completion of the transfer, the server notifies the import manager of such status (line 045), the import manager expires (line 046), and the drop box is re-opened (line 047) so that it is ready to accept another file transfer. The open status may be indicated to the user by a display on the user interface.

### EXAMPLE

The following example is put forth so as to provide those of ordinary skill in the art with a complete disclosure and description of how to make and use the present invention, and is not intended to limit the scope of what the inventors regard as their invention nor is it intended to represent that the example below is the only application for the present invention.

As noted above, implementation of a drop box with ticket system saves the user time from re-entering key metadata for each and every transfer. For example, a first researcher may conduct a first experiment on instrument 40 every day for six months for Project X and a second experiment on instrument 40 every day for Project Y. In such a situation the first researcher sets up two drop boxes, one for Project X and one for project Y. When finished with a day's experiment for Project X, the first researcher need simply drag the folder of new data files generated that day for Project X onto the drop box for Project X and the files are then automatically transferred to the cataloging database system 20 along with associated metadata information corresponding to metadata categories previously identified in the ticket associated with the drop box for Project X. The first researcher also may transfer the files from the day's experiment for Project Y in a similar manner, i.e., by dragging a folder containing the new data files generated that day for Project Y onto the drop box for Project Y.

Integrating the components of the ticket system to save necessary metadata information, along with the intuitive understanding of dragging and dropping folders provides the user with the most efficient method of transferring and importing complex data files into a cataloging database system.

It will be appreciated that, although specific embodiments of the invention have been described herein for purposes of illustration, various modifications may be made without departing from the spirit and scope of the invention. In particular, algorithms other than the one described in the pseudocode above, may be used to according to the present invention to obtain the described results or similar results in a hierarchy that is different in many ways.

In accordance with yet further alternatives, multiple files and nested folders of files may be imported per drop. Further, multiple drop boxes may upload simultaneously.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, hardware, software, process, process step or steps, to the objective, spirit and scope of the present invention. All such modifications are intended to be within the scope of the claims that follow and that define the present invention.

1. A method of facilitating an efficient and intuitive transfer of files from a computer to a storage device, said method comprising the steps of:
setting up a template for storing files to a particular location on the storage device, wherein upon set up, said template stores metadata information regarding the particular location where the files are to be stored;
creating a drop box to be regulated according to metadata information stored in said template;
transferring the set up template to the computer for use thereof; and
adding the drop box to a user interface of the computer, wherein the drop box automatically transfers the files from the computer to the particular location of the storage device when the files are dragged and dropped on said drop box.

2. The method of claim 1, wherein the computer is a client computer and the storage device comprises centralized storage means, said centralized storage means being accessible to the client computer over a network

3. The method of claim 1, wherein said metadata information further includes metadata characterizing the files to be stored

4. The method of claim 1, wherein said metadata information further includes user identification data.

5. The method of claim 1, wherein said metadata regarding the particular location where the files are to be stored in the storage device is set up in said template by a user's act of accessing the storage device and navigating to the particular location.

6. A method of efficiently and intuitively transferring files between a computer and a storage device, said method comprising the steps of:
dragging and dropping a file to be transferred onto a drop box provided on a user interface of the computer;
checking metadata associated with the file to determine whether the file is valid to be transferred via said drop box; and
if the file determined to be valid, automatically sending the file to a predefined location in the storage device.

7. The method of claim 6, wherein the computer is a client computer and the storage device comprises centralized storage means, said centralized storage means being accessible to the client computer over a network.

8. The method of claim 6, wherein the predefined location is identified by metadata stored in a template associated with said drop box.

9. The method of claim 6, further comprising extracting and sending metadata associated with said file to the predefined location in the storage device.

10. The method of claim 9, wherein the file and extracted metadata are stored in the predefined location of the storage device.

11. The method of claim 6, further comprising repeating the steps of claim 6 with at least one additional file.

12. The method of claim 6, wherein the file is encrypted prior to sending to the storage device.

13. The method of claim 6, wherein, if access to the storage device cannot be established when the file is determined to be valid, said drop box stores the file to be transferred and automatically transfers the file when access to the storage device can again be established.

14. A method of efficiently and intuitively transferring files between a computer and a storage device, said method comprising the steps of:
setting up a drop box application within the storage device for storing files to a particular location in the storage device;
initializing the drop box application on the computer; and
automatically sending a file and associated metadata by said drop box application to the particular location in the storage device.

15. The method of claim 14, wherein the computer is a client computer and the storage device comprises centralized storage means, wherein said sending takes place over a network interconnecting said client computer and said centralized storage means.

16. The method of claim 14, further comprising repeating the step of automatically sending with regard to additional files that share common metadata characteristics with said file automatically sent in claim 14, without the need to carry out said setting up and initializing steps.

17. The method of claim 14, wherein the step of setting up a drop box application within the storage device comprises setting up a template for storing files to a particular location in the storage device, wherein upon set up, said template stores metadata information regarding the particular location where the files are to be stored in the storage device.

18. The method of claim 17, wherein said metadata information further includes metadata characterizing the files to be stored

19. The method of claim 17, wherein said metadata information further includes user identification data.

20. The method of claim 17, wherein the step of initializing the drop box application on the computer comprises transferring the set up template to the computer for use thereof; and adding the drop box to a user interface of the computer.

21. The method of claim 14, wherein the step of automatically sending a file and associated metadata by said drop box application to the particular location in the storage device comprises dragging and dropping the file onto a drop box icon visualized on a user interface of the computer, which activates the automatic sending by the drop box application.

22. The method of claim 20, wherein the template is stored on the computer.

23. The method of claim 18, wherein said metadata information regarding the particular location where the files are to be stored in the storage device is set up in said template by a user's act of accessing the storage device and navigating to the particular location.

24. A system for efficiently and intuitively transferring files between a computer and a storage device, comprising:
means for setting up a drop box application within the storage device for storing files to a particular location in the storage device;
means for initializing the drop box application on the computer; and
means for automatically sending a file and associated metadata by said drop box application to the particular location in the storage device.

25. The system of claim 24, wherein the computer is a client computer and the storage device comprises centralized storage means, said centralized storage means being accessible to the client computer over a network

26. The system of claim 24, wherein said means for setting up a drop box application within the storage device includes means for setting up a template for storing files to a particular location in the storage device, wherein said template stores metadata information regarding the particular location and characterizing the files to be stored in said particular location.

27. The system of claim 24, wherein said means for initializing the drop box application on the computer includes means for transferring the set up template to the computer; and means for establishing the drop box application on a user interface of the computer.

28. The system of claim 24, wherein said means for automatically sending a file and associated metadata includes a drop box icon on the user interface, said drop box icon being automatically actuatable when a valid file is dropped thereon, to automatically send the valid file and metadata associated therewith.

29. The system of claim 26, wherein said metadata information regarding the particular location where the files are to be stored in the storage device is set up in said template by a user's act of accessing the storage device and navigating to the particular location.

30. The system of claim 24, wherein said means for automatically sending further comprises means for storing the file in said drop box application when the storage device is not currently accessible by the computer, wherein said means for automatically sending automatically sends the stored file when access to the storage device is re-established.

31. A tool for facilitating an efficient and intuitive transfer of files between a computer and a storage device, comprising:
means for setting up a template for storing files to a particular location in the storage device, wherein upon set up, said template stores metadata information regarding the particular location and characterizing the files to be stored in the particular location;
means for creating a drop box to be regulated according to metadata information stored in said template;
means for transferring the set up template to the computer for use thereof; and
means for adding the drop box to a user interface of the computer, wherein the drop box automatically transfers the files from the computer to the particular location of the storage device when the files are dragged and dropped on said drop box.

32. The tool of claim 31, wherein the computer is a client computer and the storage device comprises centralized storage means, said centralized storage means being accessible to the client computer over a network.

33. The tool of claim 31, wherein said template is a ticket.

34. The tool of claim 31, wherein said means for setting up a template comprises means for automatically setting up said metadata regarding the particular location where the files are to be stored in the storage device, by a user's act of accessing the storage device and navigating to the particular location.

35. A tool for efficiently and intuitively transferring files between a computer and a storage device, said tool comprising:
a drop box automatically actuatable by dragging and dropping a file to be transferred thereon;
means for checking metadata associated with the file to determine whether the file is valid to be transferred via said drop box; and
means for automatically sending the file, when determined to be valid, to a predefined location in the storage device.

36. The tool of claim 35, wherein the computer is a client computer and the storage device comprises centralized storage means, said centralized storage means being accessible to the client computer over a network

37. The tool of claim 35, further comprising means for storing metadata identifying the predefined location, wherein said drop box accesses said metadata to determine where to send the file.

38. The tool of claim 35, further comprising means for extracting and sending metadata associated with said file to the predefined location in the storage device.

39. The tool of claim 35, further comprising means for storing the file prior to automatic sending, wherein, if access to the storage device cannot be established when said file is determined to be valid, said drop box stores the file to be sent and automatically sends the file when access to the storage device is re-established.

40. A computer readable medium carrying one or more sequences of instructions for facilitating an efficient and intuitive transfer of files between a computer and a storage device, wherein execution of one or more sequences of instructions by one or more processors causes the one or more processors to perform the steps of:
setting up a template for storing files to a particular location in the storage device, wherein upon set up, said template stores metadata information regarding the particular location and characterizing the files to be stored in said particular location;
creating a drop box to be regulated according to metadata information stored in said template;
transferring the set up template to the computer for use thereof; and
adding the drop box to a user interface of the computer, wherein the drop box automatically transfers the files from the computer to the particular location of the storage device when the files are dragged and dropped on said drop box.

41. A computer readable medium carrying one or more sequences of instructions for efficiently and intuitively transferring files between a computer and a storage device, wherein execution of one or more sequences of instructions by one or more processors causes the one or more processors to perform the steps of:
automatically activating a transfer process when a file to be transferred is dropped onto a drop box provided on a user interface of the computer;
checking metadata associated with the file to determine whether the file is valid to be transferred via said drop box; and
if the file determined to be valid, automatically sending the file to a predefined location in the storage device.

42. A computer readable medium carrying one or more sequences of instructions for efficiently and intuitively transferring files between a computer and a storage device, wherein execution of one or more sequences of instructions by one or more processors causes the one or more processors to perform the steps of:
setting up a drop box application within the storage device for storing files to a particular location in the storage device;
initializing the drop box application on the computer; and
automatically sending a file and associated metadata by said drop box application to the particular location in the storage device.
